(19) United States
(12) Patent Application Publication
(10) Pub. No.: US 2024/0244683 A1
(43) Pub. Date: Jul. 18, 2024

(54) Reader and Access Device Operation for Access Control without Bluetooth Low Energy Pairing

(71) Applicant: Apple Inc., Cupertino, CA (US)

(72) Inventors: Lochan Verma, Danville, CA (US); Martijn T. Haring, Utrecht (NL); Florian Galdo, Emerald Hills, CA (US); Su Khiong Yong, Palo Alto, CA (US); Siegfried Lehmann, Sunnyvale, CA (US); Yann Ly-Gagnon, San Francisco, CA (US)

(21) Appl. No.: 18/537,062

(22) Filed: Dec. 12, 2023

Related U.S. Application Data
(60) Provisional application No. 63/479,927, filed on Jan. 13, 2023.

(51) Int. Cl. H04W 76/11; H04W 76/14

(52) U.S. Cl. CPC H04W 76/11; H04W 76/14

(57) ABSTRACT

This disclosure relates to techniques for access control operation between devices in a wireless communication system. An access device may store reader group identifier information for one or more reader devices. The access device may receive an advertisement indication from a reader device in a wireless manner. The advertisement indication may include a reader group identifier for the reader device. The access device may determine that the reader group identifier information stored by the access device includes the reader group identifier indicated by the reader device. The access device may attempt to perform access control communication exchange with the reader device based at least in part on determining that the reader group identifier information stored by the access device includes the reader group identifier indicated by the reader device.

### PRIORITY INFORMATION

This application claims priority to U.S. provisional patent application Ser. No. 63/479,927, entitled “Reader and Access Device Operation for Access Control without Bluetooth Low Energy Pairing,” filed Jan. 13, 2023, which is hereby incorporated by reference in its entirety as though fully and completely set forth herein.

### TECHNICAL FIELD

The present application relates to wireless communication, including to techniques for performing reader and device operation for access control without Bluetooth Low Energy pairing.

### DESCRIPTION OF THE RELATED ART

Wireless communication systems are rapidly growing in usage. Further, wireless communication technology has evolved from voice-only communications to also include the transmission of data, such as Internet and multimedia content.

Mobile electronic devices may take the form of smart phones or tablets that a user typically carries. Wearable devices (also referred to as accessory devices) are a newer form of mobile electronic device, one example being smart watches. Additionally, low-cost low-complexity wireless devices intended for stationary or nomadic deployment are also proliferating as part of the developing “Internet of Things”. In other words, there is an increasingly wide range of desired device complexities, capabilities, traffic patterns, and other characteristics.

One use case for wireless communication includes access control mechanisms, for example for providing a wireless key type functionality between a user device (such as a smart phone or watch) and a device with “reader” functionality such as a smart lock, appliance, or other device with controlled access. Managing such operation in a secure and resource-efficient manner may present unique challenges. Accordingly, improvements in the field are desired.

### SUMMARY

Embodiments are presented herein of, inter alia, systems, apparatuses, and methods for performing access control in a wireless communication system.

According to the techniques described herein, a reader device may be configured with a reader group identifier, knowledge of which may also be provisioned to an access device. The reader device may advertise the reader group identifier, such that the access device may receive an indication of the reader group identifier for the reader device when receiving the advertisement transmission from the reader device during device discovery by the access device.

Based on the pre-provisioned knowledge of the reader group identifier by the access device, the access device may determine to proceed with further access control communication exchange with the reader device, potentially including establishing a Bluetooth Low Energy connection and performing one or more Fine Ranging Consortium or Connectivity Standards Alliance based access control communication exchanges with the reader device.

At least in some embodiments, an access device configured for reader group identifier use may be able to avoid proceeding beyond discovery with reader devices that are unknown to the access device. For example, for a reader device that advertises a reader group identifier that is unknown to an access device, or that does not advertise a reader group identifier, the access device may determine to not proceed with further access control communication exchange, potentially avoiding Bluetooth Low Energy (or other type of) connection establishment altogether. Use of such a reader group identifier may thus reduce power consumption, wireless medium usage, and communication with unknown devices, at least according to some embodiments. Further, possible one-to-many assignment of reader group identifiers to reader devices may result in a potentially relatively low impact on memory use for access devices, at least in some instances.

The techniques described herein may be implemented in and/or used with a number of different types of devices, including but not limited to base stations, access points, cellular phones, portable media players, tablet computers, wearable devices, reader devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system, according to some embodiments;

FIGS. 2-3 are block diagrams illustrating example wireless devices, according to some embodiments;

FIG. 4 is a flowchart diagram illustrating an example method for performing access control between wireless devices, according to some embodiments;

FIG. 5 illustrates an example wireless communication system with multiple reader devices, according to some embodiments;

FIGS. 6-7 are signal flow diagrams illustrating aspects of example methods for performing access control between wireless devices, according to some embodiments;

FIGS. 8-9 are tables illustrating aspects of possible example BLE advertisement frames including reader group identifiers, according to some embodiments;

FIG. 10 is a signal flow diagram illustrating example aspects of a possible technique for avoiding a privacy gap when using a reader group identifier to identify a reader device, according to some embodiments;

FIG. 11 is a table illustrating aspects of another possible example BLE advertisement frame including a reader group identifier, according to some embodiments; and

FIG. 12 illustrates further details regarding possible reader group identifier computation at a reader device, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The following are definitions of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well as any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

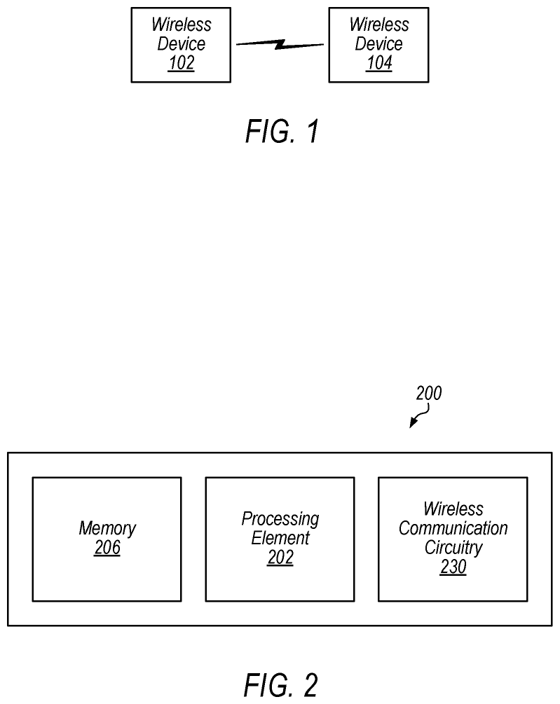

FIG. 1 illustrates an exemplary (and simplified) wireless communication system 100 in which aspects of this disclosure may be implemented. It is noted that the system of FIG. 1 is merely one example of a possible system, and embodiments of this disclosure may be implemented in any of various systems, as desired.

As shown, the exemplary wireless communication system includes a (“first”) wireless device 102 in communication with another (“second”) wireless device 104. The first wireless device 102 and the second wireless device 104 may communicate wirelessly using any of a variety of wireless communication techniques, potentially including Bluetooth Low Energy (BLE) based wireless communication techniques.

As one possibility, the first wireless device 102 and the second wireless device 104 may be capable of performing communication for access control without performing BLE pairing. One or both of the wireless device 102 and the wireless device 104 may also be capable of communicating via one or more additional wireless communication protocols, such as any of Wi-Fi, Bluetooth (BT) classic, near field communication (NFC), LTE, LTE-Advanced (LTE-A), NR, ultra wideband (UWB), etc.

The wireless devices 102, 104 may be any of a variety of types of wireless device. As one possibility, one or more of the wireless devices 102, 104 may be a substantially portable wireless user equipment (UE) device, such as a smart phone, hand-held device, a wearable device, a tablet, a motor vehicle, or virtually any type of wireless device. As another possibility, one or more of the wireless devices 102, 104 may be a substantially stationary device, such as a set top box, media player (e.g., an audio or audiovisual device), gaming console, desktop computer, appliance, door, or any of a variety of other types of device.

Each of the wireless devices 102, 104 may include wireless communication circuitry configured to facilitate the performance of wireless communication, which may include various digital and/or analog radio frequency (RF) components, a processor that is configured to execute program instructions stored in memory, a programmable hardware element such as a field-programmable gate array (FPGA), and/or any of various other components. The wireless device 102 and/or the wireless device 104 may perform any of the method embodiments described herein, or any portion of any of the method embodiments described herein, using any or all of such components.

Each of the wireless devices 102, 104 may include one or more antennas for communicating using one or more wireless communication protocols. In some cases, one or more parts of a receive and/or transmit chain may be shared between multiple wireless communication standards; for example, a device might be configured to communicate using either of Bluetooth or Wi-Fi using partially or entirely shared wireless communication circuitry (e.g., using a shared radio or at least shared radio components). The shared communication circuitry may include a single antenna, or may include multiple antennas (e.g., for MIMO) for performing wireless communications. Alternatively, a device may include separate transmit and/or receive chains (e.g., including separate antennas and other radio components) for each wireless communication protocol with which it is configured to communicate. As a further possibility, a device may include one or more radios or radio components which are shared between multiple wireless communication protocols, and one or more radios or radio components which are used exclusively by a single wireless communication protocol. For example, a device might include a shared radio for communicating using either of 4G or 5G, and separate radios for communicating using each of Wi-Fi and Bluetooth. Other configurations are also possible.

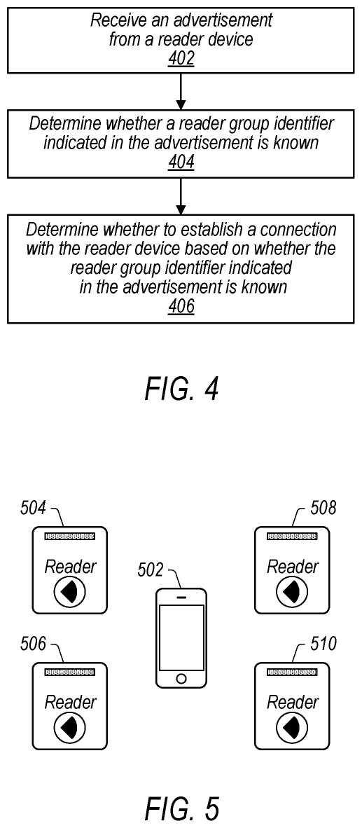

As previously noted, aspects of this disclosure may be implemented in conjunction with the wireless communication system of FIG. 1. For example, the wireless devices 102, 104 may communicate using one or more access control communication techniques or features described subsequently herein with respect to FIGS. 4-12. By utilizing such techniques (and/or other techniques described herein), the wireless device(s) may (at least according to some embodiments) be able to achieve secure and resource-efficient wireless access control.

FIG. 2 illustrates an exemplary wireless device 200 that may be configured for use in conjunction with various aspects of the present disclosure. The device 200 may be any of a variety of types of device and may be configured to perform any of a variety of types of functionality. The device 200 may be a substantially portable device or may be a substantially stationary device, potentially including any of a variety of types of device. The device 200 may be configured to perform one or more secure ranging wireless communication techniques or features, such as any of the techniques or features illustrated and/or described subsequently herein with respect to any or all of FIGS. 4-12.

As shown, the device 200 may include a processing element 202. The processing element may include or be coupled to one or more memory elements. For example, the device 200 may include one or more memory media (e.g., memory 206), which may include any of a variety of types of memory and may serve any of a variety of functions. For example, memory 206 could be RAM serving as a system memory for processing element 202. Other types and functions are also possible.

Additionally, the device 200 may include wireless communication circuitry 230. The wireless communication circuitry may include any of a variety of communication elements (e.g., antenna for wireless communication, analog and/or digital communication circuitry/controllers, etc.) and may enable the device to wirelessly communicate using one or more wireless communication protocols.

Note that in some cases, the wireless communication circuitry 230 may include its own processing element (e.g., a baseband processor), e.g., in addition to the processing element 202. For example, the processing element 202 might be an ‘application processor’ whose primary function may be to support application layer operations in the device 200, while the wireless communication circuitry 230 might be a ‘baseband processor’ whose primary function may be to support baseband layer operations (e.g., to facilitate wireless communication between the device 200 and other devices) in the device 200. In other words, in some cases the device 200 may include multiple processing elements (e.g., may be a multi-processor device). Other configurations (e.g., instead of or in addition to an application processor/baseband processor configuration) utilizing a multi-processor architecture are also possible.

The device 200 may additionally include any of a variety of other components (not shown) for implementing device functionality, depending on the intended functionality of the device 200, which may include further processing and/or memory elements (e.g., audio processing circuitry), one or more power supply elements (which may rely on battery power and/or an external power source) user interface elements (e.g., display, speaker, microphone, camera, keyboard, mouse, touchscreen, etc.), and/or any of various other components.

The components of the device 200, such as processing element 202, memory 206, and wireless communication circuitry 230, may be operatively coupled via one or more interconnection interfaces, which may include any of a variety of types of interface, possibly including a combination of multiple types of interface. As one example, a USB high-speed inter-chip (HSIC) interface may be provided for inter-chip communications between processing elements. Alternatively (or in addition), a universal asynchronous receiver transmitter (UART) interface, a serial peripheral interface (SPI), inter-integrated circuit (I2C), system management bus (SMBus), and/or any of a variety of other communication interfaces may be used for communications between various device components. Other types of interfaces (e.g., intra-chip interfaces for communication within processing element 202, peripheral interfaces for communication with peripheral components within or external to device 200, etc.) may also be provided as part of device 200.

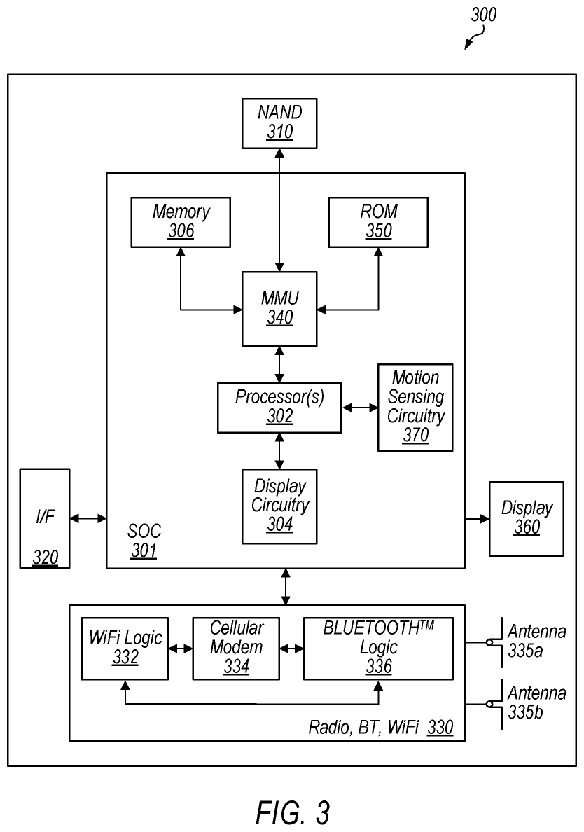

FIG. 3 illustrates one possible block diagram of a wireless device 300, which may be one possible exemplary implementation of the device 200 illustrated in FIG. 2. As shown, the wireless device 300 may include a system on chip (SOC) 301, which may include portions for various purposes. For example, as shown, the SOC 301 may include processor(s) 302 which may execute program instructions for the wireless device 300, and display circuitry 304 which may perform graphics processing and provide display signals to the display 360. The SOC 301 may also include motion sensing circuitry 370 which may detect motion of the wireless device 300, for example using a gyroscope, accelerometer, and/or any of various other motion sensing components. As another possibility, the sensor circuitry 370 may include one or more temperature sensing components, for example for measuring the temperature of each of one or more antenna panels and/or other components of the wireless device 300. Any of various other possible types of sensor circuitry may also or alternatively be included in wireless device 300, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, flash memory 310). The MMU 340 may be configured to perform memory protection and page table translation or set up. In some embodiments, the MMU 340 may be included as a portion of the processor(s) 302.

As shown, the SOC 301 may be coupled to various other circuits of the wireless device 300. For example, the wireless device 300 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, Bluetooth, Wi-Fi, NFC, GPS, etc.).

The wireless device 300 may include at least one antenna, and possibly multiple antennas (e.g., illustrated by antennas 335a and 335b), for performing wireless communication with base stations and/or other devices. Antennas 335a and 335b are shown by way of example, and wireless device 300 may include fewer or more antennas. Overall, the one or more antennas are collectively referred to as antenna 335. For example, the wireless device 300 may use antenna 335 to perform the wireless communication with the aid of radio circuitry 330. As noted above, the wireless device 300 may in some embodiments be configured to communicate wirelessly using multiple wireless communication standards or radio access technologies (RATs).

The wireless device 300 may include hardware and software components for implementing methods for the wireless device 300 to perform techniques for access control operation between devices in a wireless communication system, such as described further subsequently herein. The processor(s) 302 of the wireless device 300 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for access control operation between devices in a wireless communication system according to various embodiments disclosed herein. Processor(s) 302 may also implement various other applications and/or end-user applications running on wireless device 300.

In some embodiments, radio 330 may include separate controllers dedicated to controlling communications for various respective RAT standards. For example, as shown in FIG. 3, radio 330 may include Wi-Fi Logic 332, cellular logic 334 (e.g., LTE, LTE-A, NR, etc. controller), and Bluetooth Logic 336, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in wireless device 300. The Wi-Fi Logic 332 may enable the wireless device 300 to perform Wi-Fi communications, e.g., on an 802.11 network. The Bluetooth Logic 336 may enable the wireless device 300 to perform Bluetooth communications. The cellular modem 334 may be capable of performing cellular communication according to one or more cellular communication technologies.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

Wireless access control may include techniques for a device with access credential information to communicate with another device that controls access to something in order to obtain that access. At least according to some embodiments, a device with access information that is interested in using that information to obtain access that is controlled by another device may be referred to herein as an “access device,” while the device controlling the access may be referred to herein as a “reader device.” Other terminology for such functionality is also possible.

One part of wireless access control may commonly include discovery and identification of devices of interest, often using transmission of advertisement indications, for example using communication exchanges in accordance with or otherwise based on Bluetooth Low Energy (BLE) communication techniques. In some scenarios, it could be possible that BLE pairing is performed between an access device and a reader device during their first encounter, and that the access device can uniquely and securely identify the reader device during subsequent encounters using the pairing information. However, storing pairing information for a potentially unlimited number of reader devices that could be encountered by an access device (for example, if the access device is a highly mobile user device such as a smart phone or smart watch that may encounter a large number of reader devices over time) may represent an unreasonable burden on the access device, and, similarly, storing pairing information for a potentially unlimited number of access devices that could encounter a reader device may represent an unreasonable burden on the reader device.

As another possibility, in the absence of any way of identifying whether a reader device is a device of interest prior to initiating a BLE connection, an access device could establish a BLE connection with every reader device that advertises to the access device. However, such an approach may cause relatively high power consumption and inefficient medium usage, as well as potentially increase exposure to unknown devices.

Thus, it may be beneficial to specify techniques for supporting discovery for access control operation without performing BLE pairing. To illustrate one such set of possible techniques, FIG. 4 is a flowchart diagram illustrating a method for performing access control in a wireless communication system, which may be performed without BLE pairing, at least according to some embodiments.

Aspects of the method of FIG. 4 may be implemented by a wireless device, e.g., in conjunction with one or more other wireless devices, such as wireless devices 102, 104 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 4 are described in a manner relating to the use of communication techniques and/or features associated with Bluetooth Low Energy specification documents, such description is not intended to be limiting to the disclosure, and aspects of the method of FIG. 4 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 4 may operate as follows.

An access device may receive an advertisement indication from a (“first”) reader device (402). The advertisement indication may be transmitted by the first reader device and received by the access device in a wireless manner. The advertisement indication may include a BLE advertisement indication or an advertisement indication that is designed based at least in part on a BLE advertisement indication, at least in some instances. The advertisement indication from the first reader device may include a (“first”) reader group identifier for the first reader device. It may further be possible that the advertisement indication from the first reader device includes one or more additional reader group identifiers, for example if the first reader device is configured to be a member of multiple groups of readers. As another possibility, if the first reader device could be configured to be a member of multiple groups of readers, the first reader device may transmit a separate advertisement indication for each reader group identifier associated with the first reader device.

The access device may have reader group identifier information (e.g., including one or more reader group identifier values) stored for one or more reader devices. The reader group identifier information may include information that the access device is configured with by another device; for example, a separate deployment backend device that configures the access device with access credential information for one or more reader devices may also provide reader group identifier information for the reader device(s) to the access device as part of the configuration. The same or a similar deployment backend device could also configure the reader device(s) with reader group identifier information; in other words, the first reader device might receive information configuring the first reader group identifier for the first reader device.

As another possibility, it may be possible for the access device itself to configure one or more reader devices with a reader group identifier and to store the reader group identifier as part of the configuration, so that it can be used by the access device (and potentially other access devices) to identify the reader device(s) as device(s) of interest during subsequent encounters. For example, in a home deployment scenario, in which the access device is a user's smart phone, the user might configure various door locks, smart appliances, and/or other devices in the user's home in a group with a single reader group identifier. The user might then also be able to provision one or more other access devices (e.g., for other family members, guests, or others to whom the user wishes to grant access) with the reader group identifier for the home group. In other words, it may be possible for an access device to act as a deployment backend device performing reader group identifier configuration for reader devices and/or provisioning for other access devices. Note that numerous other deployment scenarios may also or alternatively be possible, potentially including any or all of corporate environments, hospitality environments, or health care facilities, among various others.

Note that, at least according to some embodiments, it may be possible that multiple reader devices are configured with the same reader group identifier. Thus, the access device and/or a deployment backend device could configure the first reader device and one or more additional devices all with the first reader group identifier, as one possibility. It may also or alternatively be possible that a reader device can be configured with multiple reader group identifiers, for example so that the reader device can be assigned to multiple overlapping (e.g., where the overlap includes at least the reader device) groups of reader devices. Thus, the first reader device could receive information configuring at least a second reader group identifier (e.g., in addition to the first reader group identifier), and possibly multiple further reader group identifiers, as one possibility. In such a scenario, it could be the case that the first reader device transmits a second advertisement indication in a wireless manner to carry the second reader group identifier, and possibly additional separate advertisement indications for any other additional reader group identifiers. Alternatively, it could be the case that the first reader device includes the second reader group identifier (and possibly any additional reader group identifiers associated with the first reader device) in the same advertisement indication that includes the first reader group identifier. As a still further possibility, it may be the case that a reader device can only be configured with one reader group identifier at a time, and that configuration of a new reader group identifier for a reader device effectively overwrites an existing reader group identifier, or that an existing reader group identifier for a reader device is required to be decommissioned before a new reader group identifier can be configured for the reader device.

The reader group identifier may be included in the advertisement indication in any of various possible ways. In some instances, the manner in which a reader group identifier is provided by a reader device may depend on whether a 2 octet universally unique identifier (UUID) or a 16 octet UUID is advertised by the reader device. For example, as one possibility, the reader group identifier may be indicated in a reader group identifier advertisement data (AD) field of a BLE advertisement packet with AD type set as 2 octet service UUID, e.g., when a 2 octet service UUID is used. As another possibility, the reader group identifier may be indicated in a reader group identifier UUID AD field of a BLE advertisement packet with AD type set as 16 octet reader group UUID, e.g., when a 16 octet service UUID is used. Numerous variations and alternative designs for including one or more reader group identifier values in an advertisement indication are also possible.

After receiving the advertisement indication from the first reader device, the access device may determine whether the first reader group identifier (or possibly any of multiple reader group identifiers) indicated in the advertisement indication from the first reader device is known to the access device (404). For example, the access device may determine whether reader group identifier information stored by the access device includes the first reader group identifier, and if the first reader group identifier is one that has been provisioned to and is stored by the access device, the first reader group identifier may be considered known to the access device, at least according to some embodiments. The access device may similarly determine if any other reader group identifiers advertised by the first reader device are known to the access device, if applicable.

The access device may determine whether to attempt to perform access control communication exchange with the first reader device based at least in part on whether the first reader group identifier is known to the access device (406). For example, in some embodiments, the access device may attempt to perform access control communication exchange with the first reader wireless device if the one or more reader group identifiers stored by the access wireless device include a reader group identifier for the first reader wireless device and if service UUID resolution for the first reader wireless device is successful. Attempting to perform access control communication exchange with the first reader device may include establishing a BLE based wireless connection. Additionally (or alternatively), e.g., if the BLE connection is successfully established including successful mutual authentication, the access control communication exchange may include performing one or more of Fine Ranging (FiRa) Consortium or Connectivity Standards Alliance (CSA) based access control techniques.

If the first reader group identifier is not known to the access device (e.g., the reader group identifier or identifiers stored by the access wireless device do not include the first reader group identifier, and potentially any other reader group identifiers associated with the first reader device), it may be the case that the access device determines to not attempt to perform access control communication exchange with the first reader device. In such a scenario, the access device may not proceed with BLE connection establishment or further access control communication after receiving the advertisement indication from the first reader device.

It may be possible for the access device to perform reader device discovery with other reader devices (e.g., with the same or different reader group identifier(s)) in a similar manner. As an example, the access device could receive an advertisement indication from another (“second”) reader device in a wireless manner, which may include one or more reader group identifiers associated with the second reader device. The reader group identifier(s) for the second reader device could, for example, include the first reader group identifier (e.g., if the first reader device and the second reader device are configured as part of the same reader device group). In such a scenario, if the reader group identifier information stored by the access device includes the first reader group identifier, the access device may determine that the reader group identifier information stored by the access device includes the first reader group identifier, and may attempt to perform access control communication exchange with the second reader device based at least in part on determining that the reader group identifier information stored by the access device includes the first reader group identifier.

Thus, the method of FIG. 4 may be used to provide a framework according to which an access wireless device and a reader wireless device can perform discovery and identification of interest in proceeding with access control communications in a manner that may help reduce unnecessary power consumption, avoid unnecessary wireless medium usage, and/or reduce privacy risks from communication with unknown devices, among various possible benefits, at least according to some embodiments.

FIGS. 5-12 illustrate further aspects that might be used in conjunction with the method of FIG. 4 if desired. It should be noted, however, that the exemplary details illustrated in and described with respect to FIGS. 5-12 are not intended to be limiting to the disclosure as a whole: numerous variations and alternatives to the details provided herein below are possible and should be considered within the scope of the disclosure.

Wireless access control techniques may include communication between a device (an “access device”) that is capable of performing access or key type functionality (e.g., a user device such as a smart phone, smart watch, key fob, etc.) and a device (a “reader device”) that is capable of performing reader or lock type functionality (e.g., a smart lock, a smart home, commercial, or industrial appliance, etc.), at least according to some embodiments. As one possibility, a first such communication between such a pair of devices could include performing BLE pairing. In subsequent communications between a pair of devices that has performed BLE pairing, unique and secure identification of the reader/lock-type device by the key-type device can be performed based on the Bluetooth address carried by a BLE advertisement transmitted by the reader device. However, in practice, such an approach may encounter problems with scalability, for example in scenarios in which an access device may interact with many reader devices and/or a reader device may interact with many access devices, as the storage burden for pairing information may be undesirably large in such scenarios.

Accordingly, it may be beneficial to provide an alternative mechanism for an access device to identify reader(s) of interest during discovery and prior to initiating a BLE connection. As one such possible mechanism, reader BLE advertisements could be designed to carry a reader group identifier, which can be used to identify a single reader or a group of readers of interest. The reader group identifier of a reader of interest to an access device may be known a-priori to the access device. Possible format and configuration options for such a reader group identifier are described herein, at least according to some embodiments.

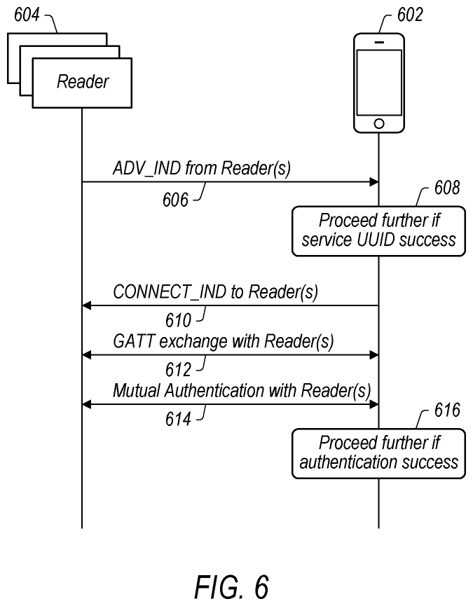

FIG. 5 illustrates example aspects of a scenario in which an access device 502 (e.g., a phone) can interact with any or all of multiple reader devices 504, 506, 508, 510 (and possibly any number of additional reader devices). As previously noted, it may be unrealistic to expect access and reader devices to store a potentially infinite amount of pairing information, so techniques for performing access control operation without performing BLE pairing may be particularly useful. FIG. 6 is a communication flow diagram illustrating aspects of one such possible approach to performing access control communication between an access device 602 and one or more reader devices 604, according to some embodiments. As shown, the access device 602 may receive an advertising indication (606) from the reader(s) 604. For each such advertisement, the access device 602 may proceed further if service UUID resolution is successful (608). Proceeding further with BLE connection establishment may include providing a connection indication (610), performing a GATT exchange (612), and performing mutual authentication (614). After BLE connection establishment, the access device and reader device(s) can proceed with access control communication exchange (e.g., in accordance with Fine Ranging (FiRa) Consortium based access control techniques, Connectivity Standards Alliance (CSA) based access control techniques, etc.) (616). Thus, in the scenario of FIG. 6, access device 602 may not have any way of identifying reader devices of interest during discovery and prior to initiating a BLE connection, and so may establish a BLE connection with every reader device 604 discovered. Such an approach may potentially suffer from relatively high power consumption, inefficient wireless medium usage, and/or exposure to privacy (tracking) risks from possible BLE connections established with devices that are not of interest.

Thus, an approach in which an access device establishes a BLE connection with every reader it receives an advertisement packet from may suffer from power consumption, privacy, and inefficiency concerns, while an approach in which an access device and a reader device perform BLE pairing (e.g., where readers' advertisement packet uses a resolvable private address (RPA) that the access device resolves using an identity resolution key (IRK) established during pairing) may suffer from scalability concerns (e.g., as there may be a memory limit to how much pairing information is stored in an access or reader device). As another option, it could be possible to pre-distribute an IRK of a reader device of interest to an access device without BLE pairing (e.g., out-of-band). It may be the case that an access device capable of using such an approach only performs BLE connection with reader devices for which it can resolve the address (RPA), which may be similar to the BLE pairing based approach, however, such an approach may also require BLE chipset firmware support, and may require deployment backend intervention in IRK programming and distribution to the access device.

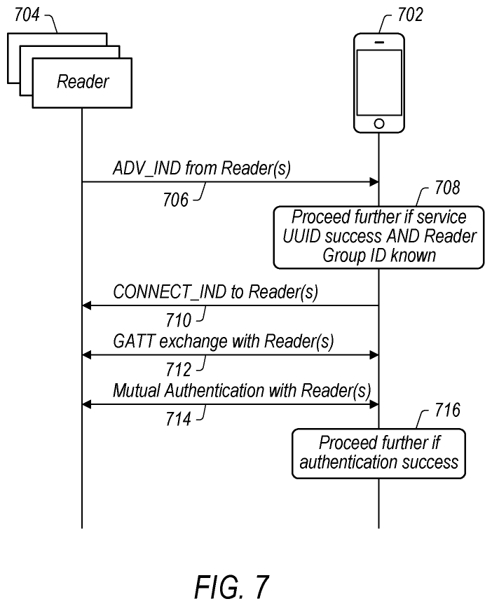

As an alternative, FIG. 7 is a communication flow diagram illustrating aspects of an approach to performing access control communication between an access device 702 and one or more reader devices 704 in which a reader group identifier is used to identify reader devices of interest to an access device without performing BLE pairing, according to some embodiments. As shown, the access device 702 may receive an advertising indication (706) from the reader(s) 704. Each such advertising indication may include one or more reader group identifier values for the corresponding reader 704. For each such advertisement, the access device 702 may proceed further if service UUID resolution is successful and a reader group ID for the reader is known (708). In some embodiments, it may be the case that this is executed in BLE firmware, e.g., to enable low power scanning and filtering of readers detected by the access device 702. Proceeding further with BLE connection establishment (e.g., only for those readers that are detected and are of interest to the access device 702) may include providing a connection indication (710), performing a GATT exchange (712), and performing mutual authentication (714). After BLE connection establishment, the access device and reader device(s) can proceed with access control communication exchange (e.g., in accordance with FiRa Consortium based access control techniques, CSA based access control techniques, etc.) (716). Thus, in the scenario of FIG. 7, access device 702 may be able to more clearly identify which reader devices are and are not of interest during discovery and prior to initiating a BLE connection, and so may establish a BLE connection with only those readers of interest and avoid establishing a BLE connection with any readers that are not of interest.

In some embodiments, it may be possible for multiple readers to have the same reader group identifier value, for example to simplify identification of a set of associated readers (e.g., readers associated with a user's home, a section of a corporate building, etc.). It may also or alternatively be possible for a reader to be configured with multiple reader group identifier values, for example in case the reader is associated with multiple different groups of readers. In some embodiments, it may be the case that deployment backend configuration of the reader group identifier is performed for the reader(s) associated with a reader group identifier, and distributed to access devices along with access credentials for the reader(s). As another option, it may be possible for an access device (e.g., with administrative privileges) to configure the reader group identifier for one or more reader devices. When a reader group identifier-based approach is used, it may be the case that the reader BLE advertisement uses a static random address generated by the reader. An access device may not need to know the static random address a-priori to identify the reader, e.g., as long as the access device knows the reader group identifier of interest a-priori.

As one possible advantage for such a reader group identifier-based approach, it may be the case that BLE chipsets widely support static random address use (e.g., no special BLE firmware requirement may be needed). Such an approach may potentially avoid BLE pairing and/or IRK pre-distribution requirements. Supporting assignment of an identical reader group identifier to multiple readers may facilitate the scalability and flexibility of such an approach, e.g., in consideration of the potential access device memory footprint to store reader group identifiers. For example, all readers in a user's home could be assigned a reader group identifier of “MyHome.” As another example, all readers in a section of a corporate building where a user works could be assigned a reader group identifier of “Section6MyBld.” Numerous other use cases are also possible.

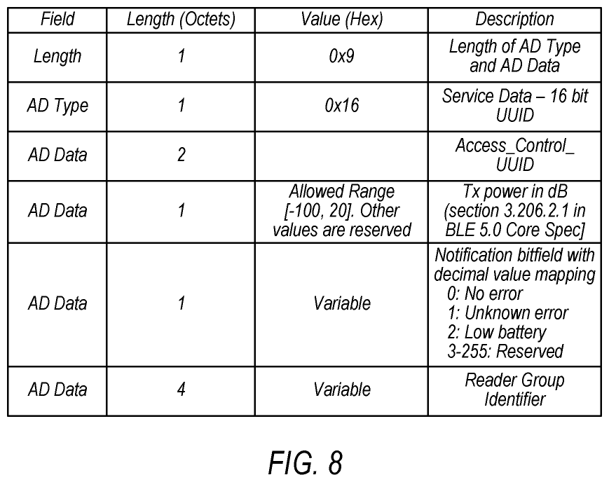

There may be multiple options for how to carry such a reader group identifier in a BLE advertisement packet. As one option, the reader group identifier may be an n octet (e.g., n=4, or any of various other possible numbers) field carried as advertisement data (AD) for the AD type “2 octet service UUID”. FIG. 8 is a table illustrating example field details for a possible BLE advertisement carrying a reader group identifier using such an approach. In particular, as shown, in the final row of the illustrated table, a 4 octet AD data field with variable value may be used to carry the reader group identifier.

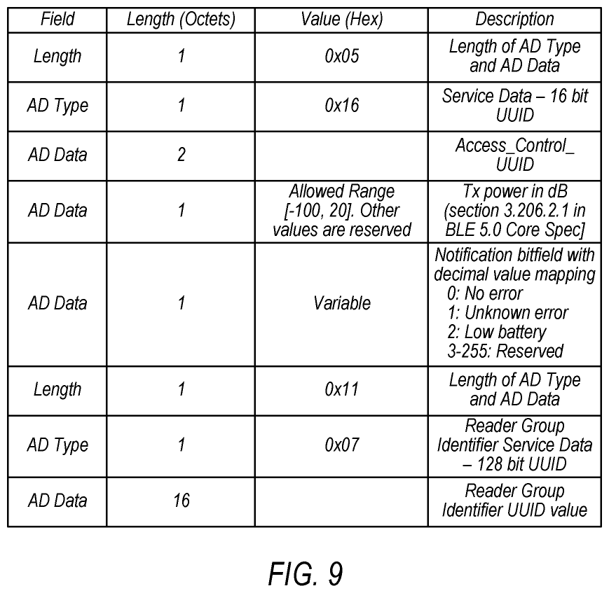

As another option, the reader group identifier may be a 128-bit service UUID for the AD type “16 octet reader group UUID.” FIG. 9 is a table illustrating example field details for a possible BLE advertisement carrying a reader group identifier using such an approach. In particular, as shown, in the final three rows of the illustrated table, a 1 octet length field, a 1 octet AD type field, and a 16 octet AD data field may be used to identify and carry the reader group identifier UUID value. Note that variations on or alternatives to the illustrated options for carrying a reader group identifier (or multiple reader group identifiers) are also possible.

In some embodiments, the reader group identifier may be a static value advertised in the BLE advertisement. In such a scenario, it may have potential to yield secondary uses such as user location tracking. For example, in a scenario in which readers are stationary and their physical locations are known to an adversary application, the adversary application may be able to create a map of reader group identifiers and their physical locations. In this scenario, if the adversary application is on a user device, it may be able to determine that the user is in proximity to the physical location of a reader device if a BLE advertisement containing a fixed reader group identifier is received

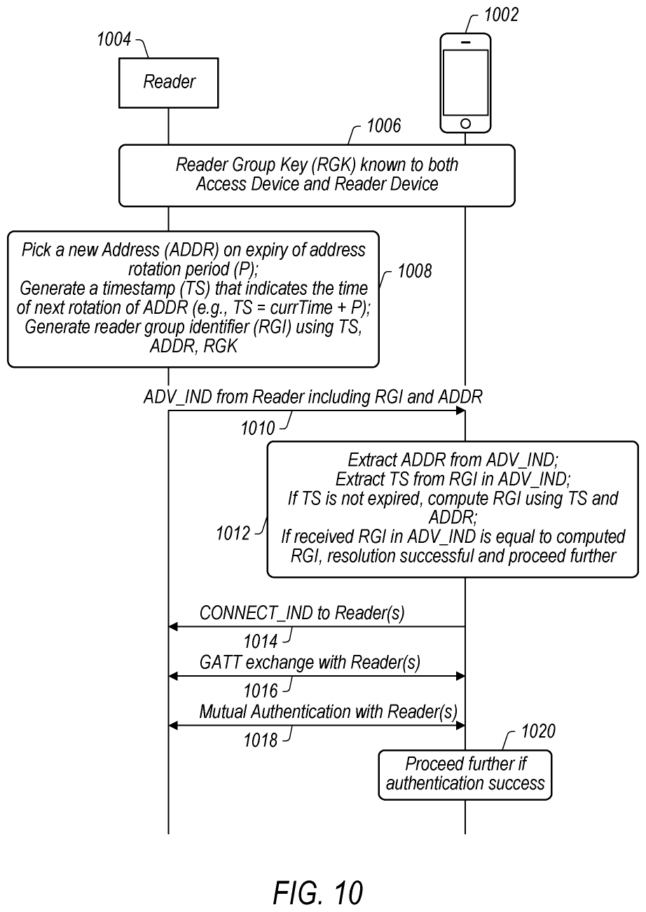

To avoid this possible privacy gap, it may be the case that the reader group identifier is not transmitted in plain text in the BLE advertisement. FIG. 10 is a communication flow diagram illustrating possible details of an approach to access device and reader device engagement when using an encrypted reader group identifier. As shown, in the illustrated scenario, a reader group key (RGK) may be known to both an access device 1002 and a reader device 1004 (1006). The reader device may pick a new address (ADDR) on expiry of an address rotation period (P), generate a timestamp (TS) that indicates the time of the next rotation of the ADDR (e.g., TS−currTime+P), and generate a reader group identifier (RGI) using the TS, ADDR, and RGK information (1008). The access device 1002 may receive an advertising indication (1010) from the reader 1004, which may include the generated RGI and the ADDR for the reader 1004. The access device 1002 may extract the ADDR from the ADV_IND, as well as the TS from the RGI in the ADV_IND; if the TS is not expired, the access device 1002 may compute the RGI for the reader device using the TS and ADDR, as well as the known RGK, and if the received RGI in the ADV_IND is equal to the computed RGI, resolution may be considered successful and the access device may proceed further with the reader device (1012). Proceeding further may include providing a connection indication (1014), performing a GATT exchange (1016), and performing mutual authentication (1018). After BLE connection establishment, the access device and reader device(s) can proceed with access control communication exchange (e.g., in accordance with FiRa Consortium based access control techniques, CSA based access control techniques, etc.) (1020).

Note that in some embodiments, the ADDR can be a static value (e.g., in lieu of a non-resolvable random private address). In such instances, the advertisement may carry a nonce value, which may have a rotation period (P). Alternatively, the address can be a static value and no nonce may be present in the advertisement. It may be the case that the size of padding bytes can vary based on the presence of nonce. The rotation period may be indicated in the advertisement. For example, a 2 bit field could be used, with values indexed to indicate 6 hours, 12 hours, 24 hours, and reserved.

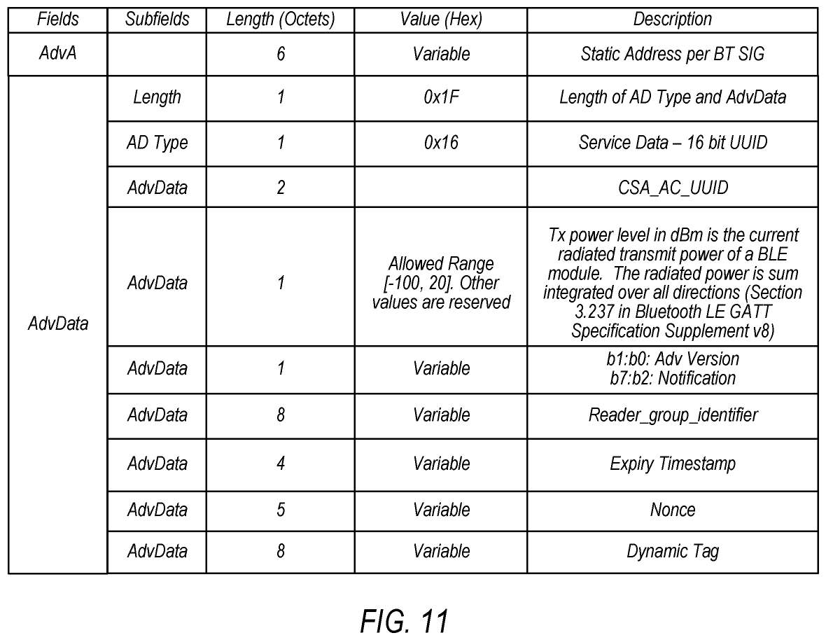

FIG. 11 is a table illustrating another example with field details for a possible BLE advertisement. In this case, an access device may filter readers of interest by parsing an AdvA field (e.g., which may indicate a static address per BT SIG, as shown) and/or reader group identifier and/or dynamic tag subfields of an advData field. The reader gropu identifier in this case may be a fixed static value configured during provisioning of the reader device. As one possibility, the Dynamic Tag may be determined as AES128Encrypt (pad Bytes |AdvA | Nonce |Expiry Timestamp, Reader Group Key).

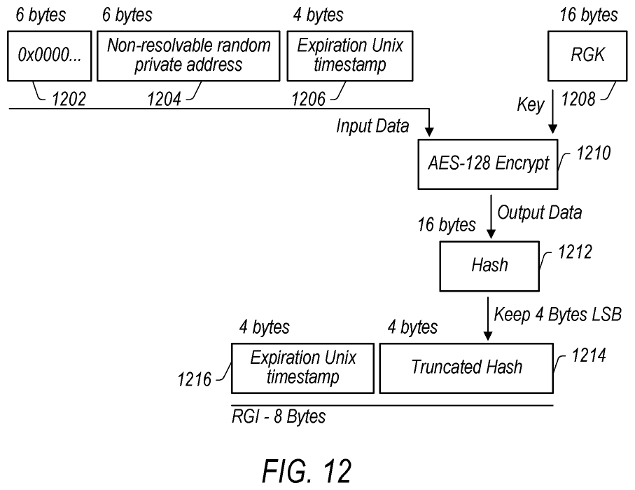

FIG. 12 illustrates further details of a possible process for performing RGI computation at the reader, according to some embodiments. As shown, a padding field (1202), an address field (1204), and an expiration timestamp field (1206) may be used as input data together with a reader group key (1208) to perform AES-128 encryption (1210). From the 16 byte hash (1212) produced as output data, the 4 least significant bytes (LSB) may be kept as a truncated hash (1214). The RGI itself may include the expiration timestamp (1216) and the truncated hash (1218).

At least according to some embodiments, the ADDR may be a non-resolvable random private address or random static address. It may be the case that the ADDR should not be a resolvable random private address because this may require pre-distribution of Identity Resolution Key to resolve the random private address. The ADDR may be carried in the ADV Address field in the Advertising Data Protocol Data Unit in a BLE advertisement. It may be the case that AES-128 crypto is used in BLE specifications, for example due to widespread support in BLE chipsets. An explicit timestamp value may be used in the RGI computation, for example so that devices that do not have reliable access to Unix time are still able to resolve the RGI. The RGI may change when the ADDR rotates. The ADDR rotation periodicity P may be any desired value (e.g., 15 min, 24 hours, etc.), at least according to some embodiments. The 6-byte field 0x000000000000 may be used as a padding value to align on the 128 bits required by the AES-128 primitive. Note that the RGI may include a timestamp to mitigate replay attacks, at least according to some embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A processor configured to cause an access wireless device to:
store configuration information comprising one or more reader group identifiers;
receive, wirelessly, an advertisement indication from a first reader wireless device, wherein the advertisement indication comprises an advertised reader group identifier associated with the first reader wireless device;
determine that a reader group identifier of the one or more stored reader group identifiers corresponds to the advertised reader group identifier associated with the first reader wireless device; and
attempt to perform an access control communication exchange with the first reader wireless device based at least in part on determining that the reader group identifier of the one or more stored reader group identifiers corresponds to the advertised reader group identifier.

2. The processor of claim 1,
wherein the advertised reader group identifier is dynamically encrypted using timestamp information and the processor is further configured to cause the access wireless device to:
determine whether the timestamp information used to dynamically encrypt the advertised reader group identifier is expired.

3. The processor of claim 1, wherein the processor is further configured to cause the access wireless device to:
attempt to perform the access control communication exchange with the first reader wireless device only after successful service universally unique identifier (UUID) resolution for the first reader wireless device.

4. The processor of claim 3,
wherein the attempt to perform the access control communication exchange with the first reader wireless device comprises establishing a Bluetooth Low Energy (BLE) based wireless connection.

5. The processor of claim 3,
wherein the attempt to perform the access control communication exchange with the first reader wireless device comprises performing one or more of Fine Ranging (FiRa) Consortium or Connectivity Standards Alliance (CSA) based access control techniques.

6. The processor of claim 1, wherein the processor is further configured to cause the access wireless device to:
receive, wirelessly, a second advertisement indication from a second reader wireless device,
wherein the second advertisement indication comprises a second advertised reader group identifier associated with the second reader wireless device,
wherein the advertised reader group identifier and the second advertised reader group identifier are the same.

7. The apparatus of claim 1,
wherein when the advertisement indication from the first reader wireless device includes multiple reader group identifiers associated with the first reader wireless device, the processor is further configured to cause the access wireless device to:
determine whether the one or more stored reader group identifiers includes a reader group identifier that corresponds to any reader group identifier of the multiple reader group identifiers associated with the first reader wireless device.

8. A method, comprising:
by an access wireless device:
storing reader group identifier information for one or more reader wireless devices;
receiving, wirelessly, an advertisement indication from a first reader wireless device, wherein the advertisement indication comprises an advertised reader group identifier associated with the first reader wireless device;
determining that a reader group identifier of the stored reader group identifier information corresponds to the advertised reader group identifier associated with the first reader wireless device; and
attempting to perform an access control communication exchange with the first reader wireless device based at least in part on determining that the reader group identifier of the stored reader group identifier information corresponds to the advertised reader group identifier.

9. The method of claim 8,
wherein the advertised reader group identifier is dynamically encrypted using timestamp information, and the method further comprises, by the access wireless device:
determining whether the timestamp information used to dynamically encrypt the advertised reader group identifier is expired.

10. The method of claim 8,
wherein attempting to perform access control communication exchange with the first reader wireless device includes establishing a Bluetooth Low Energy (BLE) based wireless connection and one or more of:
performing Fine Ranging (FiRa) Consortium based access control communication; or
performing Connectivity Standards Alliance (CSA) based access control communication.

11. The method of claim 8, wherein the method further comprises, by the access wireless device:
receiving, wirelessly, a second advertisement indication from a second reader wireless device,
wherein the second advertisement indication comprises an advertised reader group identifier associated with the second reader wireless device, determining that the reader group identifier of the stored reader group identifier information corresponds to the advertised reader group identifier associated with the second reader wireless device; and
performing an access control communication exchange with the second reader wireless device based at least in part on determining that the reader group identifier of the stored reader group identifier information corresponds to the advertised reader group identifier associated with the second reader wireless device.

12. The method of claim 8, wherein the method further comprises, by the access wireless device:
receiving configuration information including the reader group identifier information for the one or more reader wireless devices, wherein the configuration information further includes access credential information associated with the one or more reader wireless devices.

13. The method of claim 8, wherein the method further comprises, by the access wireless device, at an earlier time:
configuring the first reader wireless device with the advertised reader group identifier associated with the first reader wireless device.

14. The method of claim 13, wherein the method further comprises, by the access wireless device, at the earlier time:
configuring one or more additional reader wireless devices with a same reader group identifier as the advertised reader group identifier associated with the first reader wireless device.

15. The method of claim 8,
wherein the advertisement indication includes a Bluetooth Low Energy (BLE) advertisement packet, wherein the advertised reader group identifier associated with the first reader wireless device is indicated in one of:
a reader group identifier advertisement data (AD) field of the BLE advertisement packet with AD type set as 2 octet service universally unique identifier (UUID); or
a reader group identifier UUID AD field of the BLE advertisement packet with AD type set as 16 octet reader group UUID.

16. A reader wireless device, comprising:
an antenna;
a radio operably coupled to the antenna; and
a processor operably coupled to the radio;
wherein the reader wireless device is configured to:
receive information configuring a reader group identifier associated with the reader wireless device; and
transmit, wirelessly, an advertisement indication that comprises the reader group identifier associated with the reader wireless device.

17. The reader wireless device of claim 16,
wherein the reader group identifier comprised in the advertisement indication is dynamically encrypted using timestamp information,
wherein dynamic encryption of the reader group identifier changes according to a configured rotation period.

18. The reader wireless device of claim 16,
wherein the advertisement indication includes a Bluetooth Low Energy (BLE) advertisement packet, wherein the reader group identifier is indicated in one of:
a reader group identifier advertisement data (AD) field of the BLE advertisement packet with AD type set as 2 octet service universally unique identifier (UUID); or
a reader group identifier UUID AD field of the BLE advertisement packet with AD type set as 16 octet reader group UUID.

19. The reader wireless device of claim 16, wherein the reader wireless device is further configured to:
receive information configuring at least a second reader group identifier associated with the reader wireless device; and
transmit, wirelessly, a second advertisement indication that comprises the second reader group identifier associated with the reader wireless device.

20. The reader wireless device of claim 16, wherein the reader wireless device is further configured to:
receive information configuring at least a second reader group identifier associated with the reader wireless device,
wherein the advertisement indication further comprises the second reader group identifier associated with the reader wireless device.
